(19) United States
(12) Patent Application Publication
(10) Pub. No.: US 2012/0037544 A1
(43) Pub. Date: Feb. 16, 2012

(54) LATERAL DISPLACEMENT ARRAY FOR MICROFILTRATION

(75) Inventors: Christopher Lane, Shaker Heights, OH (US); Jeffrey T. Bargiel, Cleveland Heights, OH (US)

(73) Assignee: Logos Energy, Inc., Highland Heights, OH (US)

(21) Appl. No.: 13/265,171

(22) PCT Filed: Apr. 23, 2010
(86) PCT No.: PCT/US10/32150

§ 371 Date: Oct. 19, 2011

Related U.S. Application Data
(60) Provisional application No. 61/171,969, filed on Apr. 23, 2009.

(51) Int. Cl. B01D 29/00; B01D 29/56; B23P 11/00

(52) U.S. Cl. 209/17; 29/428; 209/156

(57) ABSTRACT

A lateral displacement array that includes a conduit in which there is an array that includes a number of vertically asymmetrical posts that are positioned in an ordered fashion that is asymmetric with respect to the direction of liquid flow within the array such that particles of at least a critical size will be laterally displaced as they flow through the array is described. Methods for separating particles having at least a critical diameter from 16 a liquid using a lateral displacement array and a microfiltration system including a number of lateral displacement arrays are also described. Array subunits suitable for the assembly of the lateral displacement array are also described that include posts on either side of a floor that are arranged on each side with half the usual density so that when the subunits are combined a lateral displacement array with the desired array of posts is formed.

### CONTINUING APPLICATION DATA

This application claims the benefit of U.S. Provisional Application Ser. No. 61/171,969, filed Apr. 23, 2009, the disclosure of which is incorporated by reference herein.

### BACKGROUND

An approach for concentrating particles in fluids has been developed at Princeton University in the laboratories of Drs. Robert Austin and James Sturm, as described in U.S. Pat. No. 7,150,812 (Huang et al.). The method for continuous particle separation described by Huang et al. was designated “deterministic lateral displacement” and the device for carrying out this process was called a “lateral displacement array” (herein referred to as an “LD array”). The LD array has demonstrated effective separation of various sized polystyrene microspheres from fluid, separation of red and white blood cells from plasma, concentration of E. coli, and the dewatering of algae. A fluid dynamic model was developed and tested to adjust the design for other applications (Huang et al., Science, 304, p. 987-990 2004; Inglis et al., Lab Chip., 6, 655-658 (2006); Davis et al., P.N.A.S, 103, 14779-14784 (2006)). This separation device is comprised of micro-fabricated periodic post arrays etched into a silicon substrate.

An example of a lateral displacement array and its principle of operation are shown in FIG. 1. As particles suspended in fluid move through the LD array, laminar flow is induced. Each row of cylindrical posts is horizontally displaced from the previous row to create precisely placed obstacles in the path of the particles flow. Where streamlines end at the surface of a post obstacle, suspended particles must circumvent the post obstacle. If the particle size is larger than the width between streamlines, the particle will be pushed, “bumped,” or laterally displaced into the adjacent streamline upon flowing around the cylindrical post (FIG. 1). Because the direction of flow will vary depending on the particle size, this flow is referred to as “deterministic.” The particle will then continue flowing in the new laminar flow stream until another post obstacle is encountered. The flow path of the particle size for which the LD array was designed (i.e., particles having the “critical diameter”) will be continually pushed laterally to a specific side of the LD array device as post obstacles are sequentially encountered. If the particle's size is smaller than the width between laminar flow streamlines, the particle will not be bumped into the next streamline but will flow in the direction of the fluid flow (downward in FIG. 1), giving no concentration or separation of that particular size of particle. The “bump event” which reflects the encounter of a particle with a post obstacle affects a specific size range of particles in the fluid that are effectively separated from other particles not in the “critical diameter range” and concentrated at the side of the LD array in the figure. The critical diameter range is determined by the gap distance between posts in a row (G; FIG. 1), the distance between posts in a column, the distance between post placement (λ; FIG. 1), and the relative horizontal shift between adjacent rows (d; FIG. 1).

Based on the parameters of the LD array (G, d, λ), particles smaller that the critical diameter range for separation do not cross streamlines and move continuously through the LD array. However, particles within the critical size range are bumped into adjacent streamlines, thereby being laterally displaced toward the side of the LD array establishing separation from the smaller particles and concentrating the desired size particles while discarding the rest.

In addition to cylindrical posts, triangular posts have also been described for use in lateral displacement arrays. (Loutherback et al., Phys. Rev. Let, 102, 045301 (2009)). An array including triangular posts (e.g., isosceles triangles) is expected to be as effective as a cylindrical post array, with the added benefit that asymmetrical streamlines allow larger gaps to be used to dewater even smaller particles, and the arrays can exhibit different behavior when flow is reversed. Additionally, there is more flow available for an LD array designed for a certain particle size with the triangular posts. The net effect is a reduction of pressure drop across the device by 50% for a given flow impedance, which will reduce pumping costs and help prevent clogging and fouling.

It can be seen that there has been significant progress in the development of lateral displacement arrays. However, the LD arrays described in the art have been prepared using the techniques conventionally used for silicon-based integrated circuits, such as dry etching, which is a relatively expensive method. Accordingly, there is a need for further improved LD arrays and an economical method for the large scale manufacturing of lateral displacement arrays which would enable the use of LD arrays for a large variety of commercial applications.

### SUMMARY OF THE INVENTION

In one aspect, the present invention provides a lateral displacement array that includes a conduit that has a floor, a substantially parallel cap, and walls connecting the outer edges of the floor and the cap, thereby forming a flowspace through which liquid can flow from an inlet at one end of the conduit to an outlet at an opposite end of the conduit; an array that includes a plurality of vertically asymmetrical posts that extend from the floor to the cap of the conduit, wherein the posts are positioned in an ordered fashion that is asymmetric with respect to the direction of liquid flow within the array such that particles of at least a critical size will be laterally displaced as they flow through the array; and a particle outlet positioned in a wall of the conduit to which the laterally displaced particles are directed.

Another aspect of the invention provides a method for separating particles having at least a critical diameter from a liquid using a lateral displacement array of the present invention. The method includes the steps of providing particles in a fluid to the entrance of the lateral displacement array, applying pressure to the fluid to cause it to flow through the array, and collecting the particles exiting from the particle outlet of the array.

Another aspect of the invention provides microfiltration system comprising a plurality of lateral displacement arrays of the present invention. The lateral displacement arrays can be positioned in parallel and/or in series relative to one another, and can also include a prefilter positioned to filter the liquid before it flows into the inlet of one or more of the lateral displacement arrays.

A further aspect of the invention provides an array subunit suitable for assembly of a lateral displacement array. The array subunits include a floor, a plurality of top posts positioned on a first side of the floor, and a plurality of bottom posts positioned on the second side of the floor, wherein the top posts and the bottom posts are positioned in rows in which the top posts and the bottom posts alternate in a staggered fashion and wherein the top posts are positioned equidistant from the two adjacent bottom posts in a row. The array subunits include posts provided at half the final placement density to facilitate manufacture of the arrays, and in some embodiments can include a recess positioned in the floor beneath the base of each of the posts configured to receive the top of a post to facilitate assembly of the arrays.

Another aspect of the invention provides a method of manufacturing a lateral displacement array that includes the steps of: preparing first and second array subunits, positioning the second array subunit over the first array subunit such that tops of the posts of the first array subunit fit within recesses positioned within the floor of the second array subunit; and providing walls connecting the outer edges of the floor of the first array subunit to the floor of the second array subunit, wherein the walls include an entrance, an exit, and a particle outlet.

### BRIEF DESCRIPTION OF THE FIGURES

The present invention may be more readily understood by reference to the following drawings wherein:

FIG. 1 provides a schematic diagram of the lateral displacement array or bump array parameters that result in shifting of critical diameter particles toward a concentration area.

FIG. 2A provides a front perspective view of a lateral displacement array, while FIG. 2B provides a cross-sectional view of the lateral displacement array.

FIG. 3 provides a schematic diagram of an ordered array of posts that is symmetric overall but is asymmetric with respect to the direction of flow as a result of tilting the array.

FIG. 4A provides a side view representation of conical posts with parameters for vertically asymmetric post designs; FIG. 4B provides a side view of trapezoidal or truncated conical shape; and FIG. 4C provides a side view of a pseudo-parabolic post.

FIG. 5 provides a graph depicting the behavior of particles as they pass through a lateral displacement array produced from cylindrical or triangular objects, with the dashed line showing the results for circular posts, and the solid line showing the results for triangular posts. The graph shows that particles of the critical size will be deflected (i.e., be in bump mode) while the smaller particles will flow through the array in pass-through mode.

FIG. 6 provides a perspective view of four lateral displacement arrays assembled side-by-side in parallel. A tank holds the particle-containing fluid above the arrays, which is gravity fed into the stack of arrays. The particles to be separated are concentrated in opposite directions such that they are combined in a common concentrated particle stream.

FIG. 7 provides a schematic diagram of two lateral displacement arrays configured to laterally displace particles having different critical diameters positioned in series. Particles at output 1 are smaller than C₁, the critical diameter of the first array in the series, those at output 2 are between size C₁ and C₂, and the ones at output 3 are larger than C₂, the critical size of the second array.

FIG. 8 provides a representational side view of array subunits with vertical, cylindrical posts that have been stacked in parallel.

FIG. 9 provides a representational side view of array subunits with vertically asymmetric tapered posts that have been stacked in parallel.

FIG. 10 provides a representative side view of array subunits with vertically asymmetric posts and recesses that have been stacked in parallel with the post tips locking into the recesses of the array subunit above.

FIG. 11 provides a representative side view of an array subunit being formed by hot embossing with two molds.

FIG. 12 provides a perspective view of post units suitable for a self-organizing assembly to form an LD array.

To illustrate the invention, several embodiments of the invention will now be described in more detail. Reference will be made to the drawings, which are summarized above. Reference numerals will be used to indicate parts and locations in the drawings. The same reference numerals will be used to indicate the same parts or locations throughout the drawing unless otherwise indicated. Skilled artisans will recognize the embodiments provided herein have many useful alternatives that fall within the scope of the invention.

### DETAILED DESCRIPTION OF THE INVENTION

The disclosed embodiments of the present invention are in the field of systems and methods for the dewatering, concentration, and/or filtration of particles or organisms from liquids. The invention is related to the economical production of particles (e.g., small organisms) that occur initially at low density such as, but not limited to, microalgae important to the production of biofuels or nutraceuticals.

### Definitions

Unless otherwise defined, all technical and scientific terms used herein have the same meaning as commonly understood by one of ordinary skill in the art to which this invention pertains. In case of conflict, the present specification, including definitions, will control.

The terminology as set forth herein is for description of the embodiments only and should not be construed as limiting of the invention as a whole. Unless otherwise specified, “a,” “an,” “the,” and “at least one” are used interchangeably. Furthermore, as used in the description of the invention and the appended claims, the singular forms “a”, “an”, and “the” are inclusive of their plural forms, unless contraindicated by the context surrounding such.

The teens “comprising” and variations thereof do not have a limiting meaning where these terms appear in the description and claims.

Also herein, the recitations of numerical ranges by endpoints include all numbers subsumed within that range (e.g., 1 to 5 includes 1, 1.5, 2, 2.75, 3, 3.80, 4, 5, etc.).

It is understood that all spatial references, such as “horizontal,” “vertical,” “top,” “upper,” “lower,” “bottom,” “left,” and “right,” are for illustrative purposes only and can be varied within the scope of the disclosure.

As used herein “critical diameter” and ‘critical particle diameter’ are used interchangeably to describe the calculated diameter of a cell or particle that allows it to be separated in the designed lateral displacement array.

As used herein, ‘lateral displacement array” refers to devices that are designed to have posts arranged in the field of flow such as to force particles having the “critical diameter” to be displaced and thereby concentrated or removed from the general culture.

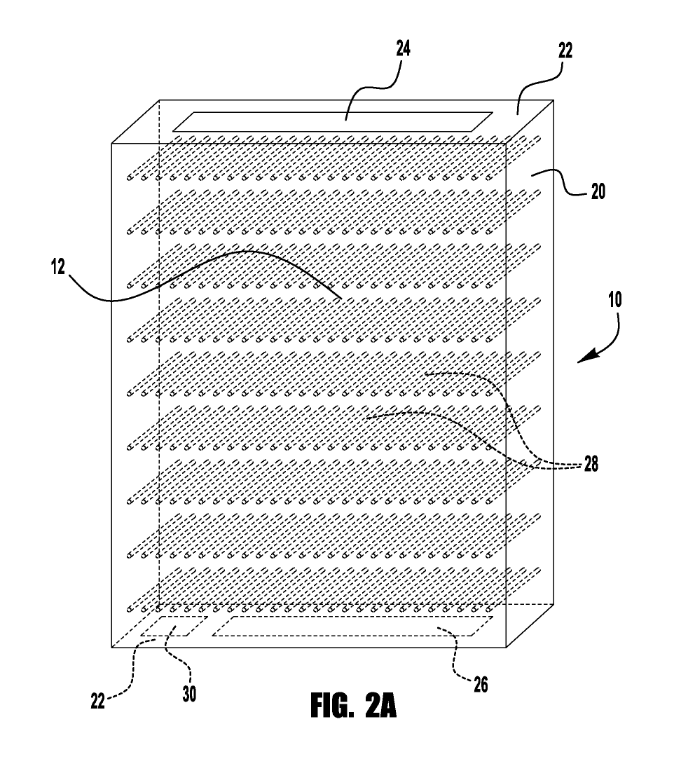

In one aspect, the present invention provides a lateral displacement array. An example of a lateral displacement array is shown in FIG. 2, which shows a front perspective view of a lateral displacement array (FIG. 2A) and a cross-sectional view of a lateral displacement array (FIG. 2B). The lateral displacement array 10 includes a conduit 12 that provides a flowspace 14 through which a liquid bearing particles can flow through the lateral displacement array 10. The conduit 12 includes a floor 16 and a cap 18 that is positioned over and substantially parallel to the floor 16. While the shape of the conduit 12 can vary, square or rectangular conduits are suitable for many embodiments of the invention. Note that in some embodiments of the invention, particularly those that include a plurality of lateral displacement arrays 10 positioned in parallel, the floor 16 can also function as the cap 18 of another adjacent lateral displacement array 10. The lateral displacement array 10 is a microfluidic device, and will therefore be manufactured in the millimeter to nanometer scale.

Walls are provided that connect the outer edges of the floor 16 and the cap 18. In some embodiments, the only walls included are side walls 20 positioned along each side of the conduit 12. In other embodiments, end walls 22 are also included and the top and bottom ends of the conduit 12. The conduit 12 also includes an inlet 24 and a liquid outlet 26 positioned at opposite ends of the conduit 12. The inlet 24 and the liquid outlet 26 are openings through which liquid can flow into and out of the conduit 12, respectively. If end walls 22 are present, the inlet 24 and the liquid outlet 26 occupy a portion of the end walls. However, in some embodiments, end walls 22 are not present and the top and bottom ends of the conduit 12 are the inlet 24 and the liquid outlet 26.

An array including a plurality of vertically asymmetrical posts 28 is provided within the conduit 12. Each of the posts 28 extend from the floor 16 to the cap 18 within the conduit 12, wherein the posts 28 are positioned in rows that are offset relative to adjacent rows in an ordered fashion such that particles of at least a critical size will be laterally displaced as they flow through the array. The critical diameter range is the size range of particles that will be laterally displaced by a lateral displacement array of the present invention.

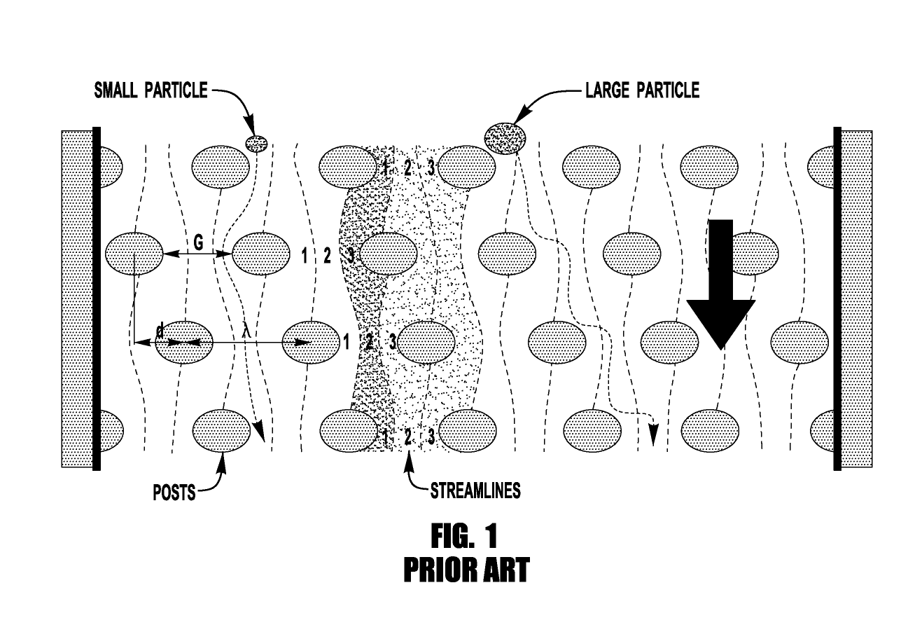

As shown in FIG. 1, the critical diameter range is determined by a variety of factors relating to the ordered positioning of the posts, including the gap distance between posts in a row, the distance between posts in a column, the distance between post placement, and the relative horizontal shift between adjacent rows. Particles smaller than the critical diameter range for separation move continuously through the lateral displacement array 10 and leave through the liquid outlet 26 with a portion of the liquid carrier. However, particles with at least the critical size are bumped into adjacent streamlines, thereby being laterally displaced toward one side of the array. This separates the larger particles from the smaller particles, and concentrates the particles with at least a critical diameter along one side of the array.

The principle of operation can be more readily understood in the context of the streamlines 1, 2, and 3 provided in FIG. 1. A particle in streamline 1 will enter streamline 2 in the next row. A particle in streamline 2 will enter streamline 3 in the next row, and a particle in streamline 3 will move to the other side of a post in the next row, thereby entering streamline 1. As a result, small particles will zig zag back and forth as they move through the array, with no net displacement, while larger particles, which must occupy streamline 2, will be consistently laterally displaced as they move through the array. For a more detailed description of the operating principles of a lateral displacement array, see U.S. Pat. No. 7,150,812 (Huang et al.).

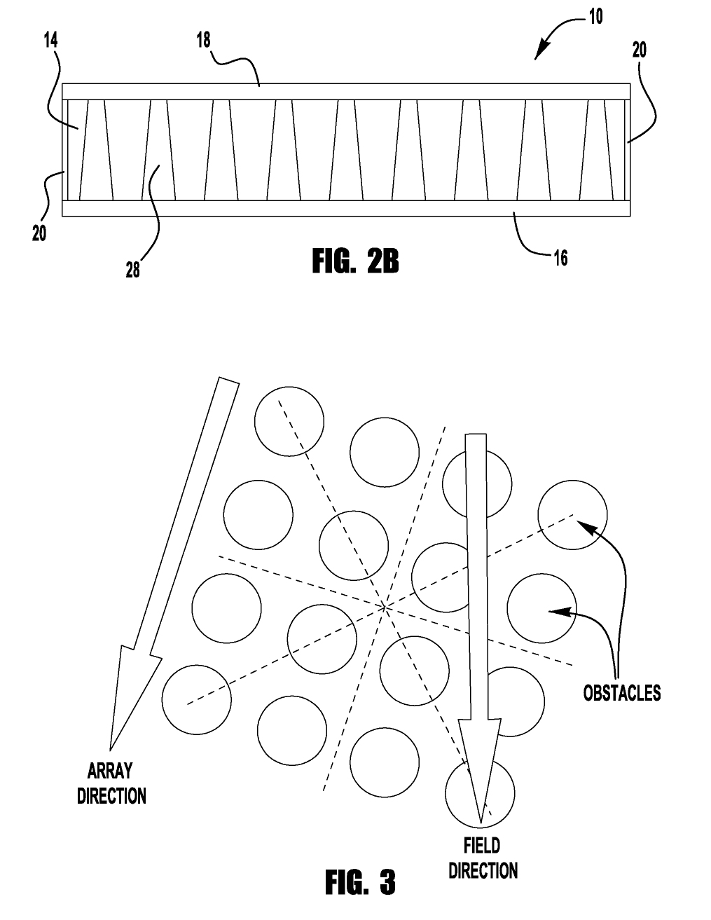

The posts in the array should be positioned to result in the lateral displacement of particles having a critical diameter or larger as they flow through the array. This is typically achieved by positioning the posts in an ordered fashion that is asymmetric with respect to the direction of liquid flow within the array. The term ordered, as used herein, refers to a generally periodic or repeating arrangement, such as a rectangular, hexagonal, or oblique arrangement of the posts. For example, this can be achieved using an array in which the posts are all positioned equidistant from one another by tilting the array at an angle other than 0° or 90° relative to the direction of flow, as shown in FIG. 3. In another embodiment, the ordered but asymmetric posts are provided by positioning the posts in rows that are offset relative to adjacent rows in an ordered fashion. The offset can also be referred to as the relative horizontal shift d, as shown in FIG. 1.

In order to collect and separate the particles that have been laterally displaced by the array, the lateral displacement array 10 also includes a particle outlet 30 positioned in a wall of conduit 12 to which the laterally displaced particles are directed. The particle outlet 30 can be positioned on an end wall 22 and/or a along the end of a side wall 20 proximal to the liquid outlet 26. Note that in embodiments of the invention, particularly those that lack a wall at the end of the conduit 12, the liquid outlet 26 and the particle outlet 30 may be directly adjacent to one another and simply represent regions of an overall outlet.

As used herein “post” or “posts” are the objects or barriers specifically placed in the array to affect lateral displacement of the targeted particle as it passes through the array. The posts have both a “horizontal” and “vertical” dimension. The vertical dimension refers to the axis that runs through the post from the floor to the cap of the conduit. The horizontal dimension refers to the axis that runs perpendicular to the vertical axis, and parallel to the floor of the conduit.

The posts included in the present invention are vertically asymmetrical in many embodiments of the invention. As used herein, “vertically asymmetrical” means a post designed to have vertical dimensions that are not uniform, i.e. not parallel sided. Examples of vertically asymmetrical posts include posts that have a base with a diameter that is smaller than the top of the post; i.e., posts that have a tapered configuration, as shown in FIG. 4A. For example, the posts can be conical posts. The conical posts can be strictly conical with linear, smooth sides that run from a larger base to a more narrow top. FIG. 4B shows a truncated conical post. Alternately, the posts can be rounded so that the sides are not smooth and linear but rather follow a curve, such as a pseudo-parabolic curve. Such posts are referred to herein as having a pseudo-parabolic configuration, as shown in FIG. 4C. As used herein “pseudo-parabolic” is used to describe post profile shape such that it is a tapered post but with a curved function between gₘᵢₙ and gₘₐₓ which is the same as or similar to a parabolic function. The vertical cross section of the tapered posts can therefore be triangular, trapezoidal, or pseudo-parabolic.

One of the problems with various prior art techniques that have been used to prepare lateral displacement arrays is that they provide posts having an insufficient height for many applications. In addition, preparation of posts having a θ of 90° is problematic for manufacturing techniques such as hot embossing or injection molding because vertical or near vertical posts will often break within the mold, resulting in manufacturing defects. Knowing the vertical limits of a manufacturing technique can provide a maximum height (h) for the posts, which can be used to calculate a suitable angle (θ), which represents the angle between the floor and the attached post. The equation used is h=(gₘₐₓ−gₘᵢₙ)/2×tan(θ). It is important to maintain a significant post height because the larger h can be, the greater flowthrough capacity the array made including these posts will tend to have. Embodiments of the present invention include posts that have a height of from about 20 μm to about 400 μm, about 50 μm to about 200 μm, or about 50 μm to about 100 μm.

As shown in FIG. 4A, when a post has a vertically asymmetric post shape (e.g., a tapered or conical shape) there are two different gap sizes between the posts. Within the figure, h is post height, θ is the angle of the base of the post, gₘᵢₙ is the post to post distance at the base and gₘₐₓ is the post to post distance measured from the top of two adjacent posts. The shorter distance; i.e., the gap minimum, is gₘᵢₙ, while the larger distance; i.e., the gap maximum, is gₘₐₓ. For a conical shape such as that shown in the figure, the gap minimum and maximum will differ to an extent corresponding to the angle θ. Another way to measure the slope of the posts is the draft angle, which equals 90 minus θ. The draft angle in embodiments of the present invention is typically fairly small. Embodiments of the invention can include posts having a draft angle that is greater than 0° and less than or equal to 4°, greater than 0° and less than or equal to 2°, or greater than 0° and less than or equal to 1°.

The prior art such as Huang et al. describes the use of a lateral displacement arrays that operate in a deterministic, completely predictable manner, requiring strictly vertical posts that are expensive to manufacture and only function for a very tight range of particle sizes. Because the present invention includes posts that have a different gₘᵢₙ and gₘₐₓ, these arrays will operate in a stochastic, or partially random fashion. While stochastic operation is not advantageous per se, use of an array including vertically asymmetrical posts that operate in a stochastic manner facilitates low-cost manufacturing and operation because non-vertical posts are easier to manufacture. Allowance for stochastic operation will also provide tolerance for the occasional missing or deformed posts, which also increases the ease of manufacture. While stochastic operation can result in the occasional movement of a particle having at least a critical size in a direction contrary to the overall lateral displacement, this will have little overall effect on the overall movement of the particles through the array, and can be compensated for if necessary by increasing the length of the array through which the particles flow.

In addition to varying along the vertical dimension, the posts can also have a variety of shapes in the horizontal dimension. For example, the posts can have horizontal cross-sections that are circular, oval, square, rectangular, or triangular. While the horizontal shape of the posts can have an effect on the trajectory of particles within the array (see for example the effect of triangular posts described by Loutherback et al., Phys. Rev. Let. 102, 045301 (2009) in some situations, particularly if the direction of flow is changed, it is the relative arrangement of the gaps between the posts that generally governs the lateral displacement mechanism, and therefore the horizontal shape of the posts can vary substantially. In some embodiments, all of the posts have the same shape, while in other embodiments, the shapes of the posts may vary within the array.

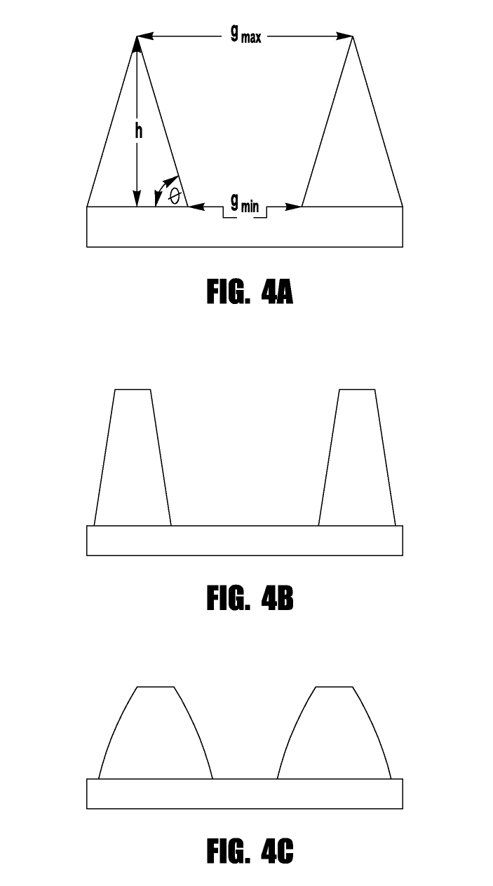

As shown in FIG. 5, the critical diameter (D_{c}) is the smallest diameter of a particle that will result in the particle being bumped for a row shift fraction (ε), and gap width (g). The row shift fraction ε equals the horizontal shift d divided by the periodic spacing of the posts in a row (λ). The gap gₘₐₓ is the gap width associated with the smallest D_{c}. If this were not true, then particles of the desired D_{c} might slip through a portion of the gap where the gap width was not small enough to induce bumping. Furthermore, although any particle above a certain D_{c} for a given row shift fraction ε and gap diameter g will bump (FIG. 5), there is actually a physical limit whereby particles cannot enter the LD array because they are the same size as or larger than the gap-width. The gap gₘᵢₙ represents the maximum size particle that can flow through the array without blocking a gap.

As will be noted further herein, embodiments of the invention may include a prefilter of additional upstream arrays or other filtration materials to prevent the lateral displacement array from being clogged by particles having a size greater than gₘᵢₙ. It is often preferable to include a prefilter before the LD array that can remove particles above the size of the gap. The prefilter could be another LD array with a critical diameter equal to or smaller than the gap size of the next LD array. This is often important for real world applications where the desired culture, production mixture, or sample will contain many components in addition to the particle targeted for separation. This is especially true for algal systems, as both enclosed and outdoor photobioreactors are seldom unialgal and free of contaminants.

Smaller gap sizes represent a more challenging design and manufacturing problem, but are preferred for dewatering particles having a smaller, desired size. For example, a critical particle diameter of 1.8 μm is used for the small industrial alga, Nannochloropsis sp. A 1.8 μm critical particle diameter with ε=0.05 requires a gₘₐₓ=6 μm. Also suppose that the maximum particle diameter we wanted to allow to enter the LD array was 3 μm (therefore gₘᵢₙ=3 μm) and the manufacturing process requires an angle of 89.5° (e.g., injection molding terms a draft angle of)0.5°). Therefore, the maximum heights is h=(3/2))tan(89.5°)=172 μm and the diameter range of particles that could enter the array is from 1.8 to 3 μm. This example shows how sensitive post height is to draft angle and the need to stay as close to vertical as possible. If the angle is decreased by only 0.5° to 89° then the post height is cut by about half to 86 μm.

The row shift fraction ε needed to separate particles having a critical particle diameter can be obtained from the graph shown in FIG. 5, making production of LD arrays possible for nearly any size particle if the manufacturing process can be scaled appropriately. Particles with critical diameters in the area above the curves are in bump mode and will dewater or separate based on their critical diameters. However, the shape of the post also makes some difference, as the graph also indicates that triangular posts (i.e., posts with a triangular base) will separate smaller particles in an array with the same gap size when compared to an LD array including circular posts.

Embodiments of the lateral displacement array can include a variety of different minimum gap sizes, depending on the size of the particle that one would like to laterally displace. For example, embodiments of the lateral displacement array can include a minimum gap between adjacent posts in a row from about 0.5 μm to about 40 μm, or a minimum gap between adjacent posts in a row from about 0.5 μm to about 20 μm. A further embodiment can include a minimum gap between adjacent posts in a row from about 1 μm to about 10 μm.

An example of an LD array design is an LD array designed to separate the small alga Nannochloropsis sp. which has a diameter of about 1.8 μm. A small row shift fraction (ε) of 0.05 is selected. Therefore, gap sizes of 6.4 μm and 9 μm would be required for either circular or triangular LD arrays respectively. This can be determined using the graph provided in FIG. 5. If the row shift is 0.05, Dc/g for a circular post is about 0.28. If Dc is 1.8, then 1.8/g equals 0.28. By solving for g (1.8/0.28) the gap size of 6.4 μm is obtained. Also note that the gap sizes represent the maximum size of particle that can enter this particular LD array, and that a prefilter that prevents entry by particles having a size greater than the gap size should preferably by used with such an array.

Using lateral displacement arrays as described above, the present invention provides a method for separating particles having at least a critical diameter from a liquid. The method includes the steps of providing particles in a fluid to the entrance of the lateral displacement array, applying pressure to the fluid to cause it to flow through the array, and collecting the particles exiting from the particle outlet of the array. As described herein, particles having at least a critical diameter will be laterally displaced to one side of the array by their interaction with the gaps and posts included within the array.

The fluid used to provide the particles can be any fluid suitable for the particles in question. For example, the fluid may be a biological buffer when the lateral displacement array is used to separate cells or other biological materials. In some embodiments of the invention, a fluid such as a biological buffer can be added to the particles as they enter the array. This may be done to help protect the array or the particles, or to improve their flow characteristics through the array. Particles in a fluid can also be provided to the entrance of the array using a number of microfluidic channels in order to evenly disperse the particles over the top of the array.

Pressure to cause the fluid to flow through the array can be provided in a variety of different ways. For example, a pump can be used to force flow of fluid through the LD array. Examples of pumps include a simple mechanism pump or an electrophoretic field. An alternative to pump-feed is the use of a gravity-fed device. Operation of a gravity-fed unit can include the use of fluidic resistors to balance the impedance of fluid streams to maintain laminar flow.

In some embodiments of the invention, the lateral displacement arrays can be stacked with other lateral displacement arrays to form a plurality of interlocked lateral displacement arrays. The arrays can be stacked together by simply positioning multiple arrays on top of or adjacent to one another, or the lateral displacement arrays can be configured to interlock with adjacent arrays. For example, arrays can include projections and complementary cavities that hold adjacent arrays in position once they have been fit together. A plurality of lateral displacement arrays that are used together can form a microfiltration system.

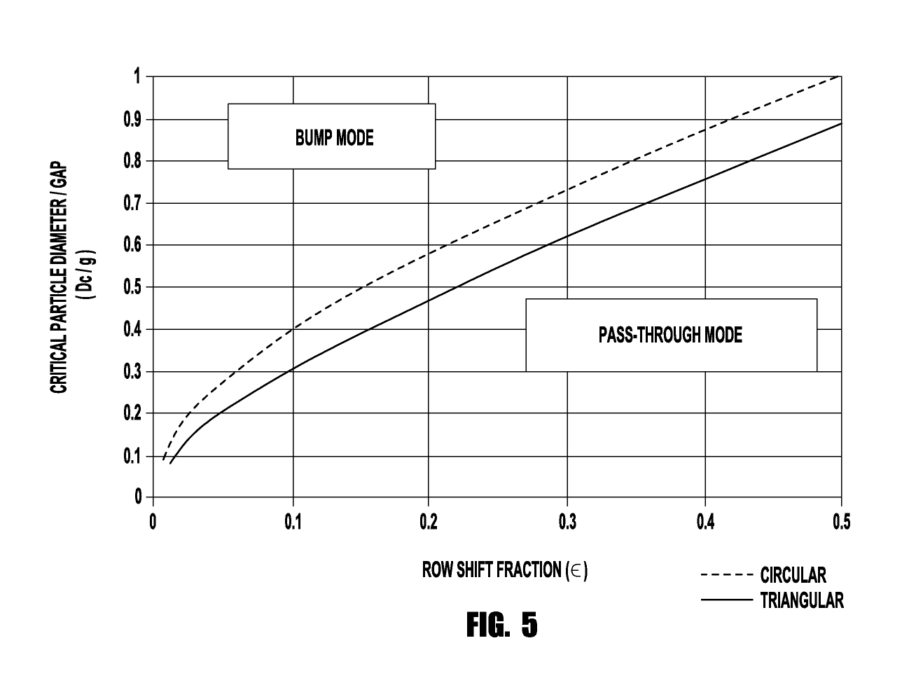

An example of a microfiltration system 40 is shown in FIG. 6. In this configuration, a plurality of lateral displacement arrays 10 are positioned beneath a fluid tank 42 such that the tank 34 is in liquid communication with the intakes 24 on the lateral displacement arrays. The particle-containing fluid then flows into the arrays from the tank 42 by gravity operation. In the embodiment shown, four LD arrays are arranged adjacent to one another such that the particles having a critical size or larger exit from the particle outlets 30 of the arrays to form a single concentrated particle stream that exits the microfiltration system 40 through a concentrated particle channel 44. The remaining fluid leaves the arrays through the outlets 26 where it flows out from the microfiltration system 40 through purified fluid channels 46.

In some embodiments, the lateral displacement arrays are positioned parallel to one another, as shown in FIG. 6. Positioning multiple LD arrays in a parallel manner can significantly increase the flow capacity of the microfiltration system. The lateral displacement arrays can also be positioned in series. When lateral displacement arrays are positioned in series, either the outlets or the particle outlets of one or more LD arrays can direct particle-containing fluid to one or more LD arrays that are configured to laterally displace particles having a different critical diameter.

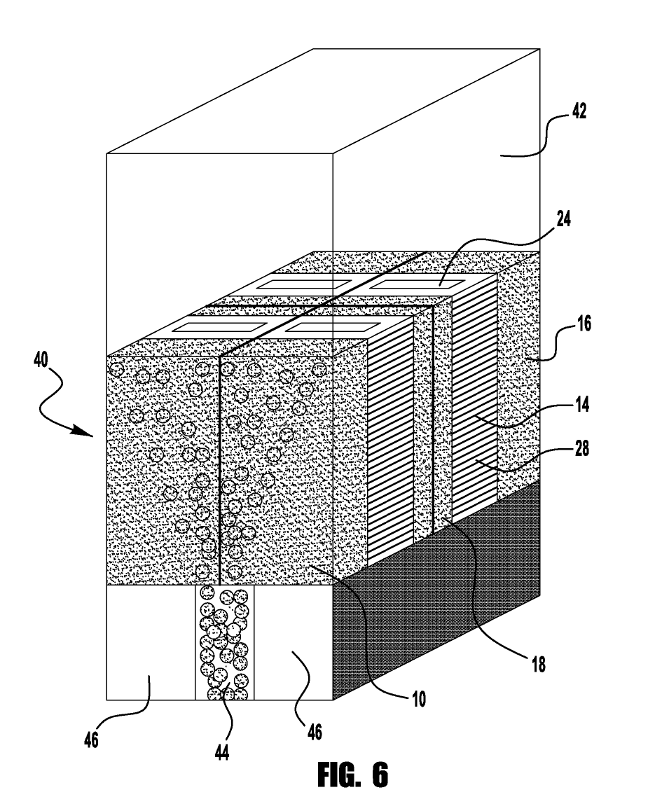

An example of arrays connected in series is shown in FIG. 7. Multiple LD arrays configured to laterally displace particles having different critical diameters that are connected in series can separate a mixture of particles into different size ranges. For example, when two arrays configured to displace particles having two different critical diameters are connected in series as shown in FIG. 7, the particles can be separated into large, medium, and small particle sizes. The sample of particles including all of these sizes is injected into the first array, which has a smaller critical diameter C₁ than the second array, which has a critical diameter of C₂. The medium and large particles are laterally displaced in the first array, while the small particles flow through. In the second array, the small and medium sized particles flow through, while only the large particles are displaced, resulting in the separation of the small, medium, and large particles.

Since multiple LD arrays with varying critical size ranges can be easily stacked in series, microfiltration systems can allow for the separation of particles over a large critical diameter range. A microfiltration system including LD arrays that are stacked in series can be directly applied to particle or cell harvesting from cultures (e.g., algal, bacterial, viral, protozoan, yeast), industrial processes (e.g., polymers, powders, latex beads, emulsions, colloidal suspensions), and biological applications (e.g., organelles, nucleic acids, medical samples). This arrangement can be used for other applications. For example, having the ability to stack in series multiple LD arrays creates a cell harvesting device that is independent of strain selection and can be designed to separate small cells or particles as well as larger particles. A device composed of stacked LD arrays in series can effectively concentrate all the biomass in any culture even if it contains a mixed population, as found often in nature, medicine, and some industrial processes. This would be of particular relevance to the algal biotechnology industry in both indoor (enclosed photobioreactors or bioreactors) and outdoor (natural light photobioreactors, raceways and open ponds) where axenic cultures are not normally utilized. An additional application is the sorting of blood cell populations. For example, white blood cells and red blood cells can be selectively concentrated into separate fractions in an arrays connected in series that are configured to separate particles having different critical diameters. See Davis, PNAS 103, p. 14779 (2006).

The microfiltration system can also include a prefilter positioned to filter the liquid before it flows into the entrance of one or more lateral displacement arrays of the microfiltration system. A prefilter is any filter that removes particles that are larger than the minimum gap size in the subsequent array to prevent that array from being clogged by particles that are too large to flow through the array. Prefilters include screens, meshes, membranes, or any other device that removes unwanted particles from the fluid stream before it enters the lateral displacement array.

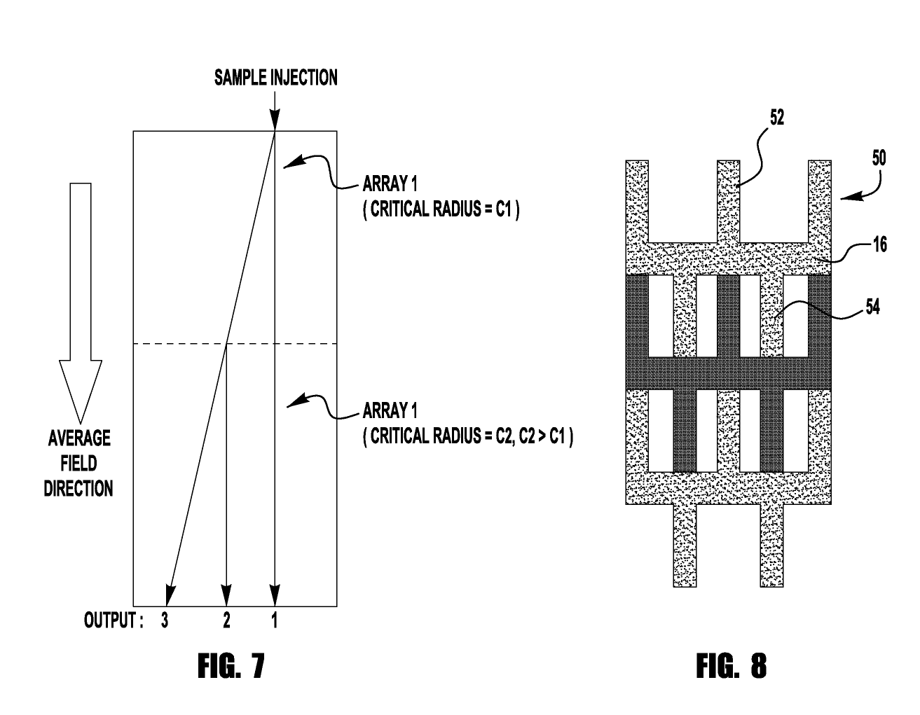

Another aspect of the invention provides array subunits that are suitable for the assembly of a lateral displacement array. The term “array subunit,” as used herein, refers to a component that can be used to prepare an array when a plurality of these components are positioned together. Various different array subunits which have been combined to form lateral displacement arrays are shown in FIGS. 8-10. All of the array subunits are “double-sided;” i.e., they include posts on both sides of the floor of the subunit.

An advantage to using double-sided array subunits is that by having posts on each side of the array subunit, the posts can be placed with half of the placement density that is usually required when preparing an array. Placement density is the number of posts in a given area of the surface of the array. This is possible because the subunits, when subsequently assembled together to form a lateral displacement array, will include posts from each side of the array subunits, thereby providing LD arrays having double the post density that was originally present on the array subunits. Detailed specifications would need to be maintained in order that the two part assembly fit securely at the post separation required for LD array particle separation by size. Because it is difficult to manufacture posts having a high placement density, the larger spacing between posts on each side of an array subunit allows for easier and less expensive manufacturing of an LD array, or the preparation of an LD array with a higher placement density than would otherwise be possible. In particular, the use of double-sided array subunits allows the use of manufacturing techniques that otherwise would not be capable of producing LD arrays having the desired post size and gap width.

FIG. 8 provides a schematic representation of three array subunits 50 that have been assembled together to form two arrays. The array subunit 50 includes a floor, a plurality of top posts 52 positioned on a first side of the floor, and a plurality of bottom posts 54 positioned on the second side of the floor, wherein the top posts 52 and the bottom posts 54 are positioned in rows in which the top posts 52 and the bottom posts 54 alternate in a staggered fashion and wherein the top posts 52 are positioned equidistant from the two adjacent bottom posts 54 in a row.

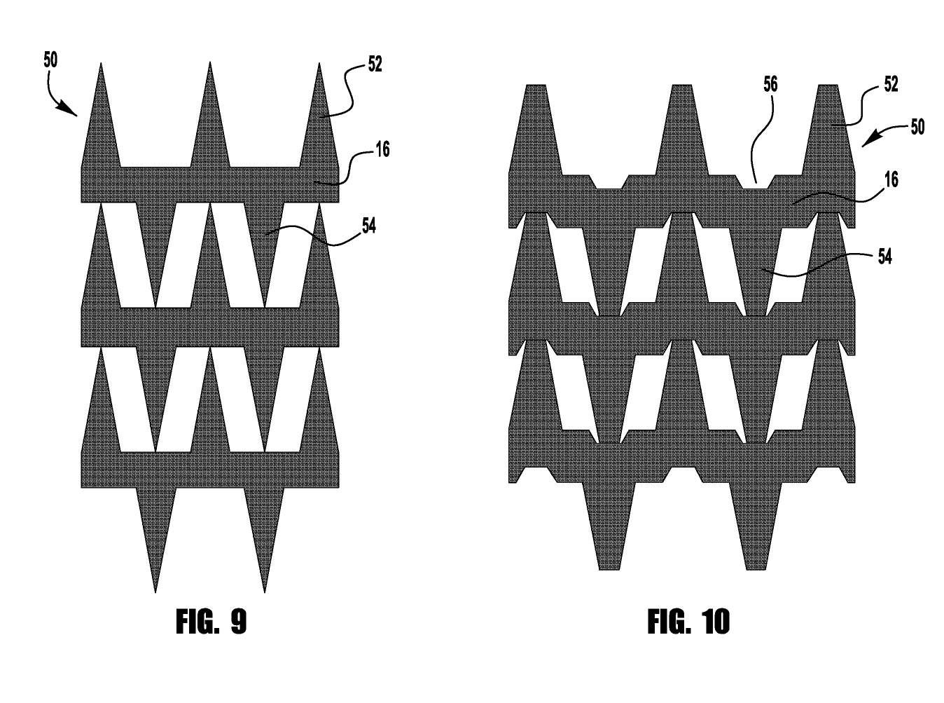

The top posts 52 and the bottom posts 54 can have the configuration of any of the posts described herein for use in a lateral displacement array. The posts included in FIG. 9 are cylindrical posts. However, the posts included in FIG. 9 and FIG. 10 are vertically asymmetric (e.g., conical) posts. An additional advantage to the use of array subunits to prepare a lateral displacement array is that it would allow vertically asymmetric posts such as those shown in FIG. 9 and FIG. 10 to provide a constant distance gₐᵥₑ (i.e., the average of gₘₐₓ and gₘᵢₙ) between posts. By placing the gₘᵢₙ regions of posts opposite from the gₘₐₓ of adjacent posts, a lateral displacement array providing essentially deterministic behavior can be produced using vertically asymmetric posts. Because the posts can be positioned with half the placement that would normally be required to obtain a lateral displacement array with the desired gap size, the gap size present on each side of the array subunits will be double that of the gap size present in the lateral displacement array after assembly. Accordingly, preferred minimum gap sizes for the top posts and the bottom posts in the array subunits are from about 1 μm to about 80 μm, from about 1 μm to about 40 μm, and from about 2 μm to about 20 μm between adjacent posts on the same side of the subunit. As with the lateral displacement arrays themselves, a substantial portion of the surfaces of the floor and the top and bottom posts of the array subunits can be coated with an anti-fouling composition.

The use of multiple arrays formed from stacked array subunits can allow for higher operating or cleaning pressures and more stable assembly. Once assembled, the posts would have support at both their bases and at their tops creating a more stable assembly able to withstand higher influent flows and pressures especially during cleaning, for example, where high pressure steam may be used. Double sided hot embossing that provides features on each side of a surface is described by H. Dittrich. (Ph.D. Dissertation, Universitat Karlsruhe 2004). In some embodiments, the arrays can be assembled within a tray to facilitate the proper alignment of the array subunits. The tray can also serve to provide walls for the assembled lateral displacement arrays.

The array subunits 50 can also include a recess 56 positioned within the floor beneath the base of each of the posts that is configured to receive the top of a post, as shown in FIG. 10. Essentially, an array subunit has posts on one surface that provides a male side and recesses on the opposite, female side that would accept the posts from the chip below it. This design can combine the advantages of vertically asymmetric posts with interlocking array subunits to provide straightforward and inexpensive manufacturing with greater strength and ease of assembly. However, recesses can also be provided for array subunits that have cylindrical posts. Including a recess 56 beneath each of the posts provides a useful means for aligning and interlocking array subunits 50. The shape of the recess 56 should match the shape of the top of the posts it is designed to receive, and if necessary be aligned appropriately to receive a post of the appropriate shape. For example, if the posts are cylindrical, the recess should be a circular depression, whereas if the posts are triangular, the recess should be a triangular depression that is aligned appropriately to receive the top portion of a triangular post. The recesses can be tapered from an oversized opening down to the size of the posts so that the posts from the chip below are guided together during assembly.

To be able to use the array subunits to form a lateral displacement array, the present invention also provides a method of manufacturing a lateral displacement array that includes the steps of: preparing first and second array subunits; positioning the second array subunit over the first array subunit such that tops of the posts of the first array subunit fit within recesses positioned within the floor of the second array subunit. Finally walls connecting the outer edges of the floor of the first array subunit to the floor of the second array subunit can be provided. The walls can be merely side walls, or the walls can also cover a portion of the ends of the array and include an entrance, an exit, and a particle outlet.

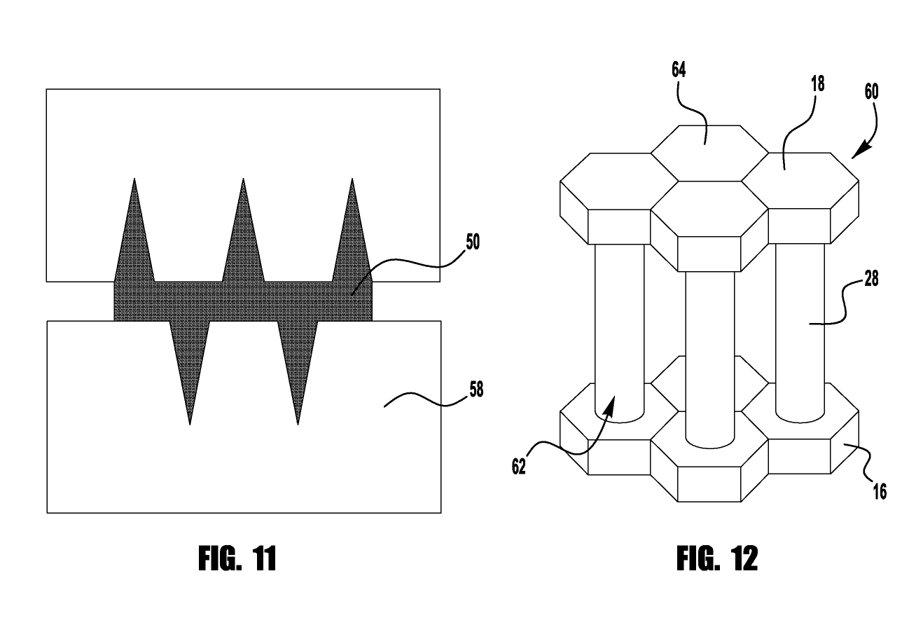

As noted earlier, one of the advantages to using vertically asymmetrical posts is that it allows manufacturing of arrays including the posts using relatively low-cost techniques. For example, hot embossing is a manufacturing technology that is not suitable for the prior LD array designs including vertical posts, but can readily be used to prepare LD arrays with vertically asymmetrical posts. Hot embossing is typically conducted by pressing a master die into a polymer disc heated to its glass transition temperature, after which the polymer disc fills the die and cools into the desired shape. FIG. 11 provides a representative side view of an array subunit 50 being formed by hot embossing with two molds 58. Fouled molds can be cleaned with a mix of solvents in an ultrasonic bath. The die is typically composed of silicon and is made via deep reactive-ion etching (DRIB) or of nickel which is formed via LIGA (Lithographie, Galvanofoimung, Abformung or in English: Lithography, Electroplating, and Molding).

It is possible to make devices with a variety of post thickness using hot embossing. For example for post thicknesses as low as 6 μm with aspect ratios of 5-15 (close to 5 is recommended for a 10 μm gap-width) allowing post sizes with a diameter of 12 μm with depths of up to 188 μm. Polymer wafers that are 100-300 mm in diameter (6-8 inch) and have a processing time of 1-5 minutes are available for use in fully automated systems such as the Jenoptik HEX04 embossing equipment. Examples of other systems which can be used include EVG by W. Benard at MEMS & Nanotechnology Exchange, Inc. Hot embossing can provide the desired aspect ratios and post sizes are attainable with inexpensive materials, and the process is commercially ready with off-the-shelf equipment, making it very suitable for full scale production.

Lateral displacement arrays can be prepared from a variety of possible polymers include but are not limited to polycarbonate (i.e., PC or Lexan®), polymethylmethacrylate (i.e., PMMA, acrylic, or Plexiglas®), Polyether Imide (PEI), Polytetrafluoroethylene (i.e., PTFE or Teflon®), and Polyetheretherketone (PEEK), all of which are much less expensive than silicon, non-toxic to algae, and relatively durable. Alternative materials are also possible and contemplated herein. Polycarbonate is recommended for its durability and mold releasing at such small element sizes, however other rugged polymers are also appropriate.

Another method which can be used to prepare the lateral displacement arrays or array subunits including vertically asymmetric posts is injection molding. Injection molding is the injection of molten thermoplastic under pressure into a mold cavity in which the plastic takes on the shape of the mold. When the plastic is allowed to cool it solidifies into the shape of the mold. It is used to make billions of components and products a year, including elements with dimensions less than 50 μm.

When using these methods, one should take into consideration the expanding and contracting of the molds during a cycle, which at micro-mold element size may lead to the potential danger of completely closing micro-cavities, as well as cracking. It is also important to precisely control shot pressure and mold fill so as not to bend or damage micro-mold elements. Heat and pressure requirements may be very high in order to overcome surface tension and force the viscous molten plastic into the micro-mold cavities. High heat and pressure put tremendous stress on the mold and require long cycle times for heating and cooling without cracking the mold. High aspect ratios mean that there is a high amount of surface area and friction when ejecting parts which may cause posts to break off and remain in the mold. Once broken, they are very difficult to remove. However, once a mold design and process is complete then mass manufacture will be low cost and high volume.

The cost for preparing the lateral displacement arrays by injection molding is expected to be about the same as for hot embossing. This is because although the materials will be the same or similar; the mold/die is likely to be constructed in similar fashion but more expensive because of mold mechanics of cooling/heating, sprue design, etc.; machinery cost is probably higher; cycle time is similar; labor requirements are similar; but injection molding molds usually create multiple components per mold effectively lowering the cycle time per part.

Lateral displacement arrays and/or array subunits can also be prepared by lithography using a photoresist. In this method, a pattern is transferred from a mask to a liquid epoxy photoresist by exposing it to an irradiation source. The source alters the physical and chemical properties of the epoxy photoresist based on the pattern of the mask. A solvent wash then removes unexposed opoxy and the desired structures from the exposed epoxy are left being. A particularly promising epoxy photoresist is SU-8, which can be used to prepare high aspect ratio micron or submicron structures that would be suitable for lateral displacement array manufacturing. The main components of SU-8 are Bisphenol A Novolak epoxy oligomer and up to 10 wt % triarylsulfonium hexafluroantimonate salt. See del Campo et al., J. Micromech. Microeng. 17, R81-R95 (2007).

The distance between posts in the LD arrays is very small and therefore performance of the LD array will be negatively impacted by biofouling of the arrays, such as the development of a biofilm and the growth of organisms in the biofilm or by sticking of matter mechanically to the posts during operation. Biofouling can sometimes be removed by pressurized back flushing of the system, flow pulsing, or high-pressure steam. However, this may not always be sufficient. Accordingly, an anti-fouling coating can be added to the surfaces of the LD array to inhibit or retard the biofouling of the surfaces of the LD array. In some embodiments, a substantial portion of the surfaces within the flowspace of the lateral displacement array is coated with an anti-fouling composition. During manufacture of the LD arrays a coating could be placed on the system to prevent mechanical sticking (e.g., anti-stick coatings such as silicone or Teflon®) and anti-biofouling (e.g., such as silver and quaternary amines). As used herein “inhibit” means to completely prevent or eradicate growth or fouling and “retard” means to lower the growth or biofouling over levels that would occur without the presence of the agent or process to reduce biofouling.

Examples of ways to inhibit or retard fouling are coating at least a portion of the array with anti-microbial and anti-bacterial agents to retard or inhibit growth of the biofilm (e.g., quaternary amines or silver), incorporation of agents to inhibit or retard growth in the material making up the array (e.g., quaternary amines or silver) or coating at least a portion of the array with metals (e.g., copper using vapor deposition methods). Silver ions used as coatings for many materials have been shown to be antimicrobial and prevent the growth and buildup of bacteria, fungi, molds, viruses, and other organisms. Silver could be incorporated into a coating or added as a dopant to the plastic used to form the arrays in this manufacturing process. A number of new applications are being used in the medical device industry to prevent microbial adhesion to implants and medical devices, including those that rely on nanoparticulate silver. See Rupp et al., Am J Infect Control 32, p. 445-450 (2004) and Simpson, K., Plastic Adhesives and Compounding, Oxford, UK (2003).

Chemical agents such as quaternary amines and other anti-bacterial and anti-microbial agents have been coated on surfaces of plastics and other materials to prevent growth of biofilms on the coated surfaces. U.S. Pat. No. 5,968,538 describes such a method wherein polyvinylpyrrolidone-iodine complex is coated on materials to prevent bioaccumulation. Other examples of chemical agents which have been coated onto or incorporated into materials include, but are not limited to bisoxirane, silicone quaternary amine agents, 2-amino-4-oxo-tricyclicpyrimidine, monocarboxylic acid antimicrobial and polyvinylpyrrolidone-iodine, nonoxynol-9, organosilicone quaternary ammonium compounds and bisguanide (chlorhexidine). Additionally, materials used to prevent fouling for marine uses such as tributyltin and block copolymers that contain semifluorinated (SF) and poly(ethylene glycol) (PEG) side groups could also be applied to this system.

Silicone or PTFE or other non-stick coating or treatments are available to prevent sticking of material to the posts. Materials used to prevent molds from sticking are also a useful approach to coating these arrays. An example would be the McLube® 1733H PTFE solvent based treatment from McGee Industries. This can be flowed through the array then air dried to leave a thin dry film of polymer that prevents adhesion to the sides and posts of the array. A number of commercial preparations are available such as SILICOAT® (D3879; Sigma Chemical) that can be used for coating with a silicon layer to prevent sticking.

Vapor deposition methods are already widely used in industry to coat plastics. Thermal evaporation is used to vaporize a metal into an atomic cloud under vacuum then the metal coats the surface of the array in a layer from 0.5 μm to 1 mm. These films could prevent sticking physically, provide heat resistance to the arrays for higher pressure and temperature steam cleaning, or act as antimicrobial layers to prevent biofouling (e.g. silver or some of the heavy metal oxides). Physical vapor deposition is line of sight coating and probably will be the cheaper method for this manufacturing procedure. However, chemical vapor deposition (CVD) methods might also be useful if the temperatures of the chemical and the plastic were compatible.

Methods developed by the Oak Ridge National Laboratories in Oak Ridge, Tennessee, as described in U.S. Pat. No. 6,750,291 by Ober et al., can also be used to prevent biofouling of the surface of LD arrays or the array subunits. Ober et al. have developed methods for producing films and powders that are extremely water repellant, or superhydrophobic. These superhydrophobic materials have surface microstructures that emulate those that appear naturally on the leaves of water-repellant plants such as the lotus. Lotus plants grow in muddy ponds and marshes, yet their leaves float clean and dry on the surface of the water as a consequence of their hydrophobic surfaces.

Other techniques can be used to prepare lateral displacement arrays. For example, lateral displacement arrays can also be prepared using dry etching. Dry etching uses high energy plasma to bombard the substrate with ions or neutral atoms. The particles react with the substrate to create a volatile that will leave the surface. It can create nearly vertical posts) (>89°) with aspect ratios of near 20 and it could be used to create molds for some type of molding or hot embossing. However, dry etching is significantly more expensive than injection molding or hot embossing.

In another embodiment of the invention, the LD array is a self-forming array 60. Self-organization is the idea that systems of parts can properly arrange themselves into the desired product. For example, a set of dumbbell-shaped self-aggregating posts 62 can be used, as shown in FIG. 12. Each of the self-aggregating posts includes a post 28 with an aggregating end 64 positioned at both ends of the post 28. The bottom aggregating ends 64 form a floor 16 when aggregated, while the top aggregating ends 64 form a cap 18 when aggregated. They could be made using a series of additive and subtractive lithography and etching techniques. If all or part of each aggregating end 64 is magnetic then they could self-organize by attracting each other or aligning under the addition of an external field. The aggregating ends 64 should have a shape that readily forms a complete surface, such as a square, triangle, or hexagon.

In a further embodiment, the LD arrays can be formed using threaded wires. The threaded wires method replaces the posts with very thin wire which is stretched between a floor and a cap to create a lateral displacement array. Possible methods include actually threading the wire through tiny holes in the floor and cap or holding the wires in a master and curing a resin to hold the wires permanently. To prepare LD arrays suitable for the separation of particles having a critical diameter of a desired size, such as that for algae, very thin wires would have to be used (e.g., wire with a diameter of 20-10 μm; AWG 50-60).

The lateral displacement arrays described herein may be used for the separation of a wide variety of particles of interest. For example, the LD arrays can be used to separate blood particles or be used as a prefilter for a reverse osmosis ultrafiltration device. Other applications include dewatering of microalgae, wastewater treatment, flow cytometry, and fluorescence activated cell sorting.

An example has been included to more clearly describe a particular embodiment of the invention and its associated cost and operational advantages. However, there are a wide variety of other embodiments within the scope of the present invention, which should not be limited to the particular example provided herein.

### EXAMPLE

### Example 1

### Lowered Costs Using LD Arrays Including Vertically Asymmetric Posts

Hot embossing can produce LD arrays from polymer at a cost of goods sold around $50/m². This low expense is the result of several factors. Hot embossing provides the advantage of using inexpensive polymer as the substrate material and further analysis reveals that it is very economical. Other costs involved vary depending on whether a gravity-fed unit or a pump-fed unit is used. It should be noted that areal costs are different for a pump-fed unit versus a gravity-fed unit because the cost of the prefilter to process the total flow of 187,500 gallons per minute (gpm) before it enters an LD array is the same regardless of the area of the LD array. A comparison of the costs involved in pump-fed and gravity fed LD arrays is shown in Table 1. The cost of 10 ft. tanks is added to the gravity-fed units based on a footprint of 1.75 acres.

TABLE 1

| | Pump-fed: | Gravity-fed: |
|---|---|---|
| Category | 20,000 m² | 250,000 m² |
| Die/Molds | $300,000 | $3,660,000 |
| Machinery | $100,000 | $1,220,000 |
| Raw Material | $350,000 | $4,400,000 |
| Labor | $225,000 | $2,750,000 |
| Prefilter | $770,000 | $770,000 |
| Tank | 0 | $2,851,000 |
| Total | $1,745,000 | $15,651,000 |
| Areal CapEx | $87.25/m² | $62.20/m² |
| CapEx per gpm | $9.30/gpm | $83.47/gpm |
| CapEx per gallon | $0.155/gal | $1.39/gal |

One of the advantages of the use of lateral displacement arrays including the features described herein is the potential reduction in capital expenditures (CapEx). The total cost per barrel of product produced (e.g., oil obtained from algae) using LD arrays prepared by hot embossing is shown in Table 2 below. The calculations are based on the understanding that 50 Mgal/year oil requires 187,500 gpm of algal culture dewatering. Adding 10% CapEx and OpEx; reveals a total cost of $4,964,500 for a pump-fed unit and $1,965,000 for a gravity-fed unit. These results support an initial development path in favor of gravity-fed units. However, the lower flow rates of a gravity fed unit may cause more biofouling and thus require more cleaning.

TABLE 2

| | Pump-fed | Gravity-fed |
|---|---|---|
| | (120 ft. head): | (10 ft. head): |
| | 20,000 m² | 250,000 m² |
| CapEx | $1,745,000 | $15,651,000 |
| OpEx | $4,790,000 | $400,000 |
| Total Cost | $4,964,500 | $1,965,100 |
| (10% CapEx + OpEx) | | |
| Total Cost per Barrel | $4.17 | $1.65 |
| Total Cost per gpm | $26.48 | $10.48 |
| OpEx per gallon | 0.0054¢/gal | 0.000449¢/gal |
| Total Cost per gal | 0.0056¢/gal | 0.00221¢/gal |

TABLE 3
Assumptions for CapEx and OpEx of Hot Embossed LD array

| | |
|---|---|
| General | 1 year to manufacture all units |
| | Running 24/7/365 |
| | Total Effective Equipment Performance (TEEP) |

68.5% Loading (weekdays only)
95% Availability
60% Performance (5 min cycle)
90% Quality

| | |
|---|---|
| Die/Molds | $60,000/die* |
| | Ø300 mm wafer* |
| | 95% areal wafer utilization |
| | 3 min cycle time |
| | 1 year mold lifetime |
| | # molds rounded to next higher integer |
| Machinery | $200,000/machine |
| | 1 machine per mold |
| | 10 years depreciation |
| | # machines rounded to next higher integer |
| Raw Material | Polycarbonate* |
| | 4 mm wafer thickness* |
| | $3,300/MT ($1.50/lb) |
| | 1.2 MT/m³ density of PC |
| Labor | $60,000/technician |
| | 3 shifts/machine |
| | 25% on task |
| Prefilter† | Tekleen ABW6-TXLP automatic self-cleaning |
| | water filter casing (carbon steel body) |
| | 50 μm stainless steel mesh filter |
| | Max. 1,500 gpm |
| | 66% Performance |
| | $16,000/casing |
| | $25,000/mesh |
| | 10 years depreciation |
| Tanks | 1.75 acre footprint × 10 ft. deep = 17.5 acre-feet |
| | $5,000 for 10,000 gal poly tank |
| Pumping | 3.136 × 10⁻⁶ kWh/ft. head-gal Engineering |
| | Factor |
| | $0.10/kWh |
| | 70% pumping efficiency |

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. A lateral displacement array, comprising
a conduit comprising a floor, a substantially parallel cap, and walls connecting the outer edges of the floor and the cap, thereby forming a flowspace through which liquid can flow from an inlet at one end of the conduit to an outlet at an opposite end of the conduit;
an array comprising a plurality of vertically asymmetrical posts that extend from the floor to the cap of the conduit, wherein the posts are positioned in an ordered fashion that is asymmetric with respect to the direction of liquid flow within the array such that particles of at least a critical size will be laterally displaced as they flow through the array; and
a particle outlet positioned in a wall of the conduit to which the laterally displaced particles are directed.

2. The lateral displacement array of claim 1, wherein the vertically asymmetrical posts have a tapered configuration.

3. The lateral displacement array of claim 1, wherein the vertically asymmetrical posts have a pseudo-parabolic configuration.

4. The lateral displacement array of claim 1, wherein the lateral displacement array comprises a polymer selected from the group consisting of polycarbonate, polymethacrylate, polyether imide, polytetrafluoroethylene, and polyetheretherketone.

5. The lateral displacement array of claim 1, wherein a substantial portion of the surfaces within the flowspace of the lateral displacement array is coated with an anti-fouling composition.

6. The lateral displacement array of claim 1, wherein the minimum gap between adjacent posts in a row is from about 0.5 μm to about 20 μm.

7. The lateral displacement array of claim 1, wherein the posts have a height of from about 50 μm to about 200 μm.

8. The lateral displacement array of claim 1, wherein the posts have a draft angle that is greater than 0° and less than or equal to 2°.

9. The lateral displacement array of claim 1, wherein the lateral displacement array is configured to stack with other lateral displacement arrays to form a plurality of interlocked lateral displacement arrays.

10. A method for separating particles having at least a critical diameter from a liquid using a lateral displacement array according to claim 1, comprising the steps of providing particles in a fluid to the entrance of the lateral displacement array, applying pressure to the fluid to cause it to flow through the array, and collecting the particles exiting from the particle outlet of the array.

11. A microfiltration system comprising a plurality of lateral displacement arrays according to any one of claim 1.

12. The microfiltration system of claim 11, wherein the lateral displacement arrays are positioned parallel to one another.

13. The microfiltration system of claim 11, wherein the lateral displacement arrays are positioned in series.

14. The microfiltration system of claim 11, further comprising a prefilter positioned to filter the liquid before it flows into the inlet of one or more lateral displacement arrays of the microfiltration system.

15. An array subunit suitable for assembly of a lateral displacement array, comprising a floor, a plurality of top posts positioned on a first side of the floor, and a plurality of bottom posts positioned on the second side of the floor, wherein the top posts and the bottom posts are positioned in rows in which the top posts and the bottom posts alternate in a staggered fashion and wherein the top posts are positioned equidistant from the two adjacent bottom posts in a row.

16. The array subunit of claim 15, wherein the posts have a cylindrical configuration.

17. The array subunit of claim 15, wherein the posts have a tapered configuration.

18. The array subunit of claim 15, wherein the vertically asymmetrical posts have a pseudo-parabolic configuration.

19. The array subunit of claim 15, wherein the array subunit comprises a polymer selected from the group consisting of polycarbonate, polymethacrylate, polyether imide, polytetrafluoroethylene, and polyetheretherketone.

20. The array subunit of claim 15, wherein a substantial portion of the surfaces of the floor and posts are coated with an anti-fouling composition.

21. The array subunit of claim 15, wherein the minimum gap between adjacent posts in a row on the same side of the subunit is from about 1 μm to about 40 μm.

22. The array subunit of claim 15, wherein the posts have a height of from about 50 μm to about 200 μm.

23. The array subunit of claim 15, wherein the posts have a draft angle that is greater than 0° and less than or equal to 2°.

24. The array subunit of any one of claim 15, further comprising a recess positioned in the floor beneath the base of each of the posts configured to receive the top of a post.

25. A method of manufacturing a lateral displacement array, comprising the steps of:
preparing first and second array subunits of claim 24;
positioning the second array subunit over the first array subunit such that tops of the posts of the first array subunit fit within recesses positioned within the floor of the second array subunit; and
providing walls connecting the outer edges of the floor of the first array subunit to the floor of the second array subunit, wherein the walls include an entrance, an exit, and a particle outlet.

26. The method of claim 25, wherein the first and second array subunits are prepared by hot embossing.

27. The method of claim 25, wherein the first and second array subunits are prepared by injection molding.

28. The method of claim 25, wherein the first and second array subunits are prepared by lithography using a photoresist.
